(19) United States
(12) Patent Application Publication
(10) Pub. No.: US 2012/0167288 A1
(43) Pub. Date: Jul. 5, 2012

(54) Thermal Vest

(76) Inventors: Yishuo Chen, Columbus, OH (US); Zhihang Chen, Beijing (CN)

(21) Appl. No.: 12/984,576

(22) Filed: Jan. 4, 2011

(51) Int. Cl. A62B 17/00; A41D 13/00; A41D 1/04

(52) U.S. Cl. 2/458; 2/102

(57) ABSTRACT

A thermal vest having a front panel sized and shaped to substantially cover a front of a wearer's torso. A back panel is spaced apart from and opposes the front panel, the back panel being sized and shaped to cover a back of the wearer's torso. At least one pocket is on an interior of at least one of the panels, the pocket having an opening sized and shaped to receive a thermal pack. An insulative pad is selectably attached to the pocket, the insulative pad being selectably movable between a stowed position facially adjacent the pocket and a deployed, non-adjacent position away from the pocket. The insulative pad provides thermal insulation between the pocket and the wearer in the stowed position and is movable by the wearer to the deployed position when thermal insulation is not desired.

### FIELD

The present invention relates to a thermal vest, more particularly to a vest with thermally efficient heating and cooling of the upper torso, front and back, of a wearer.

### BACKGROUND

There are many industrial situations requiring individuals to work in hostile environments where the temperature is so high that it cannot reasonably be tolerated for a satisfactory period of time. This is particularly true for high-temperature environments such as foundries and factories carrying out processes where the worker cannot be readily isolated from the processing itself or from hot equipment or a surrounding hot environment. Similarly, medical workers are often required to don protective garments to deter the spread of disease. Such protective garments by their nature do not lend themselves to the flow of air for evaporative cooling of the body of a wearer. Yet other situations such as fire-fighting and working out-of-doors in warm weather can expose individuals to high ambient temperatures and adversely affect both comfort and safety.

In such cases there is a need to keep radiant, conductive and/or convective heat from reaching the individual's body, particularly the torso. Where the environmental temperature or heat level is extremely high, as near an open furnace or the like, the primary concern is to intercept a large amount of the heat which would otherwise reach the worker. This may be accomplished by both reflection and adsorption. Preferably, the heat not reflected is dissipated in melting a frozen material. Insulation may also be used between the heat source and the body to further isolate heat from reaching the body.

Cooling vests utilizing frozen gel packs are known in the art. Such cooling vests include pockets or pouches into which the gel packets are inserted. The pockets are located proximate a wearer's body to help cool the wearer. A shortcoming of such vests is that the frozen gel packs may initially be too cold, causing discomfort and even frostbite to the wearer's skin. Vests having an insulating material intermediate the pouch and the wearer's skin have been devised to overcome this problem. However, a drawback of such devices is that the cooling effect of the gel packs may become prematurely ineffective due to the insulation, thereby reducing the amount of time the vest is useful to cool the body of the wearer. There is a need for a cooling vest that utilizes cooling packs that can be easily and quickly manipulated by a wearer in such a way as to regulate their cooling effect on the body of the wearer, in order to both deter discomfort due to excessive cooling while still maximizing the amount of time a cooling effect is provided by the vest.

### SUMMARY

The present invention is a thermal vest for controlling the rate of heat transfer between portions of the human body and the environment around the body. In one embodiment the present invention is used to reduce the amount of heat reaching the body from an unusually hot environment. In another embodiment the present invention may be used to reduce the body temperature by absorbing heat from the body. In still another embodiment the present invention may be used with heated packs to warm the body of the wearer in a cold environment, such as in wintry conditions out-of-doors or in refrigerated workspaces.

One aspect of the present invention includes a thermal vest having a front panel sized and shaped to substantially cover the front of a wearer's torso. A back panel is spaced apart from and opposes the front panel, the back panel being sized and shaped to cover the back of the wearer's torso. At least one pocket is on an interior of at least one of the panels, the pocket having an opening sized and shaped to receive a thermal pack. An insulative pad is selectably attached to the pocket, the insulative pad being selectably movable between a stowed position facially adjacent the pocket and a deployed, non-adjacent position away from the pocket. The insulative pad provides thermal insulation between the pocket and the wearer in the stowed position and is movable by the wearer to the deployed position when thermal insulation is not desired.

Another aspect of the present invention is a thermal vest comprising a front panel sized and shaped to substantially cover the front of a wearer's torso, the front panel having a left sub-panel and a right sub-panel. A front panel fastener selectably couples together the left and right sub-panels. A back panel is spaced apart from and opposes the front panel, the back panel being sized and shaped to cover the back of the wearer's torso. A pair of shoulder fasteners extend between the front panel and the back panel. A pair of torso fasteners also extend between the front panel and the back panel. At least one pocket is on an interior of at least one of the panels, the pocket having an opening sized and shaped to receive a thermal pack. An insulative pad is selectably attached to the pocket, the insulative pad being selectably movable between a stowed position facially adjacent the pocket and a deployed, non-adjacent position away from the pocket. The insulative pad provides thermal insulation between the pocket and the wearer in the stowed position. The insulative pad is movable by the wearer to the deployed position when thermal insulation is not desired.

### BRIEF DESCRIPTION OF THE DRAWINGS

Further features of the inventive embodiments will become apparent to those skilled in the art to which the embodiments relate from reading the specification and claims with reference to the accompanying drawings, in which:

FIG. 1 is an elevational view of the exterior of a thermal vest according to an embodiment of the present invention;

FIG. 2 is a first side elevational view of the thermal vest of FIG. 1;

FIG. 3 is an elevational view showing details of the interior of a back panel of the thermal vest of FIG. 1;

FIG. 4 is a second side elevational view of the thermal vest of FIG. 1;

FIG. 5 shows a front elevational view of a thermal insulative pad attached to a pocket in a stowed position facially adjacent a pocket according to an embodiment of the present invention;

FIG. 6 shows the insulative pad of FIG. 5 in a deployed, non-facially adjacent position away from the pocket;

FIG. 7 shows details of the interior of a front panel of the thermal vest, looking through the vest to expose layers of a pocket joined to the front panel;

FIG. 8 shows further details of the interior of the back panel of the thermal vest; and

FIG. 9 shows still further details of the back panel of the thermal vest, looking through the vest to expose layers of a pocket joined to the back panel.

### DETAILED DESCRIPTION

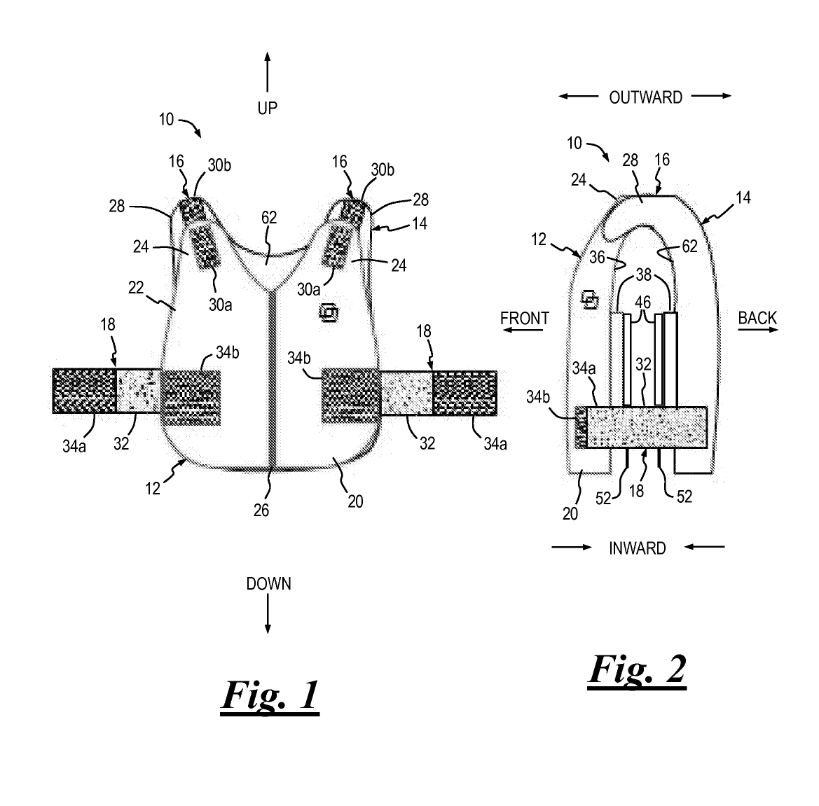

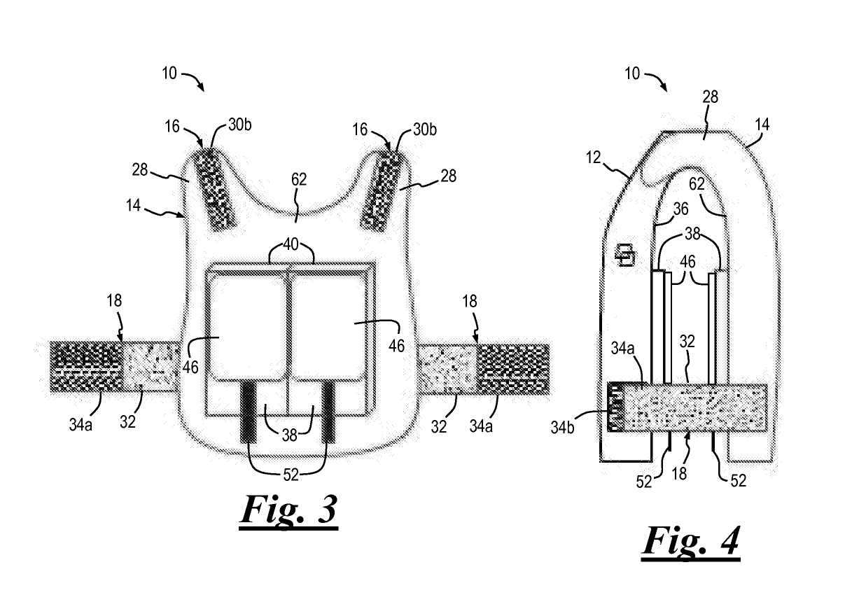

FIGS. 1 through 4 together show the general arrangement of a thermal vest 10 according to an embodiment of the present invention. Thermal vest 10 comprises a front panel 12 and a spaced-apart, opposing back panel 14. The front and back panels are selectably coupled together with a set of shoulder fasteners 16 and a set of torso fasteners 18.

Front panel 12 preferably includes a left sub-panel 20 and a right sub-panel 22, the left and right sub-panels being generally shaped as mirror images and each subpanel having a front shoulder portion 24. Sub-panels 20, 22 are selectably coupled together by a front panel fastener 26, which may take the form of a zipper, a hook-and-loop fastener, buttons, snaps, or any other type of fastener suitable for use with thermal vest 10. Sub-panels 20, 22 may be made from any material suitable for use with thermal vest 10 including, without limitation, fabrics such as flame-resistant nylon and polyester-cotton blends. Alternatively, sub-panels 20, 22 may be made of a material of a type such as that sold by DuPont Corporation under the trademark NOMEX, which is a flame retardant ceramic material. Sub-panels 20, 22 may also include an insulating material such as, but not limited to insulating material sold by 3M Company under the trademark THINSULATE. Sub-panels 20, 22 may further comprise waterproof and/or breathable fabrics, such as the material sold by W. L. Gore & Associates, Elkton, Md. under the trademark GORE-TEX.

Back panel 14 is shaped to generally correspond to the shape of front panel 12. Back panel 14 further includes a pair of back shoulder portions 28 corresponding to the front shoulder portions 24. Like front panel 12, back panel 14 may be made from any material suitable for use with thermal vest 10 including, without limitation, fabrics such as flame-resistant nylon and polyester-cotton blends. Alternatively, back panel 14 may be made from NOMEX, insulating material such as THINSULATE, and waterproof and/or breathable fabrics, such as GORE-TEX.

Shoulder fasteners 16 comprise a fastener member 30a secured to front shoulder portions 24 and a corresponding fastener member 30b secured to back shoulder portions 28. Shoulder fasteners 16 may be a hook-and-loop fastener such as that sold by Velcro USA, Inc. of Manchester, N.H. under the trademark VELCRO. Alternatively, buttons, snaps, or any other types of fasteners suitable for use with thermal vest 10 may be utilized for shoulder fasteners 16.

Torso fasteners 18 include straps 32 attached to back panel 12 as shown in FIGS. 1 and 2, or to front panel 12. Straps 32 may be made from any type of material suitable for use with thermal vest 10 including, without limitation, woven cloth or “ballistic” woven plastic material. A distal end of each strap 32 includes a fastener member 34a configured to be selectably coupled to a corresponding fastener member 34b of front panel 12. Fastener members 34a, 34b preferably comprise a hook-and-loop fastener. Alternatively, buttons, snaps, or any other types of fasteners suitable for use with thermal vest 10 may be utilized for torso fasteners 18.

With reference now to FIGS. 1 through 7 together, an interior side 36 of one or both of sub-panels 20, 22 of front panel 12 may include a pocket 38 having an opening 40, the pocket and opening being sized and shaped to receive a cooling ice or “gel” pack 42. A pocket fastener 44 may be included to selectably close off opening 40. An insulative pad 46 is selectably attached to pocket 38 by one or more pad fasteners 48. Pad 46 is also tethered to pocket 38 by one or more pad straps 50, the pad straps having a length sufficient to move the pad away from the pocket. One or more pull tabs 52 are joined to pad 46, and extend away from and below the pad.

Pocket 38 may be made from any material suitable for use with thermal vest 10 including, without limitation, fabrics such as flame-resistant nylon. Alternatively, back panel 14 may be made from NOMEX, insulating material such as THINSULATE, and waterproof and/or breathable fabrics, such as GORE-TEX.

Cooling pack 42 may be any type of freezable cooling pack suitable for thermal vest 10. Example cooling packs include, without limitation, packaged ice or a refrigerant gel. Alternatively, cooling pack 42 may be solid nitrate or ammonium chloride as part of an endothermic reaction process.

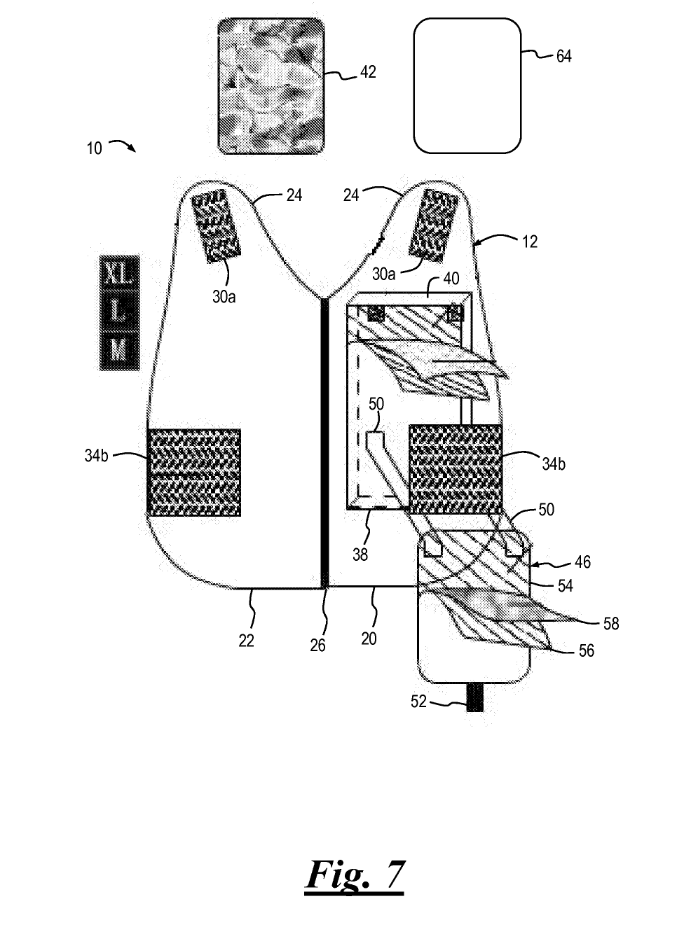

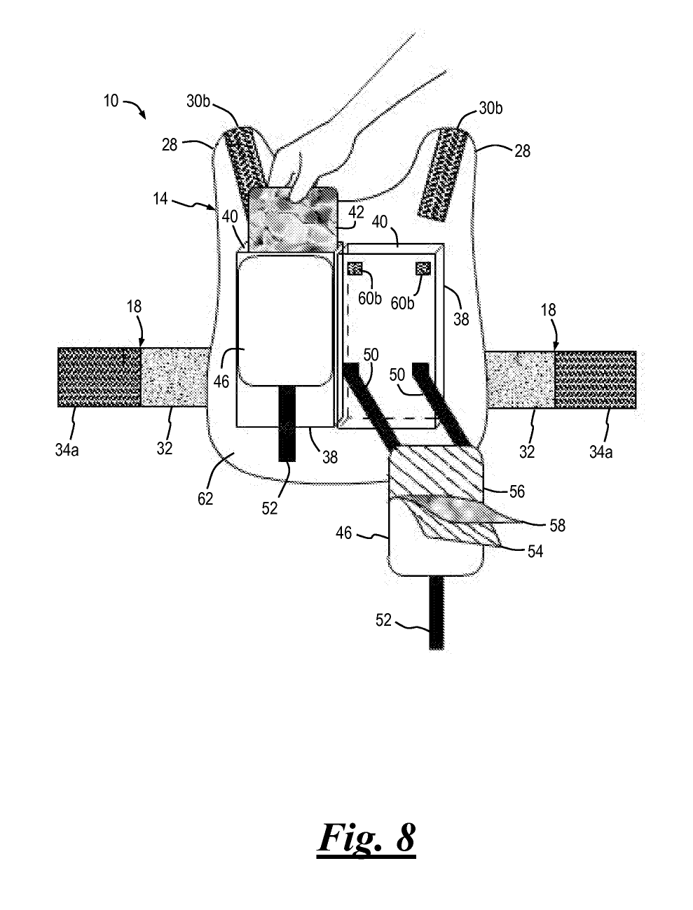

Insulative pad 46 may be made from a suitable number of layers of any material suitable for use with thermal vest 10 including, without limitation, fabrics such as flame-resistant nylon. Insulative pad 46 may also include NOMEX, insulating material such as THINSULATE and polyethylene foam, and waterproof and/or breathable fabrics, such as GORE-TEX. In one embodiment, shown in FIGS. 7-9, pad 46 comprises a polyester-cotton inner layer 54, a polyester-cotton outer layer 56 and a THINSULATE or polyethylene (ETE) plastic foam thermal protective insulating layer 58 intermediate the inner and outer layers.

Pad fasteners 48 comprise a pad fastener member 60a attached to pad 46 and configured to be selectably coupled to a corresponding pocket fastener member 60b of pocket 38. Fastener members 60a, 60b preferably comprise a hook-and-loop fastener. Alternatively, buttons, snaps, or any other types of fasteners suitable for use with thermal vest 10 may be utilized for pad fasteners 48.

Pull tabs 52 may be made from any type of material suitable for use with thermal vest 10 including, without limitation, woven cloth or “ballistic” woven plastic material.

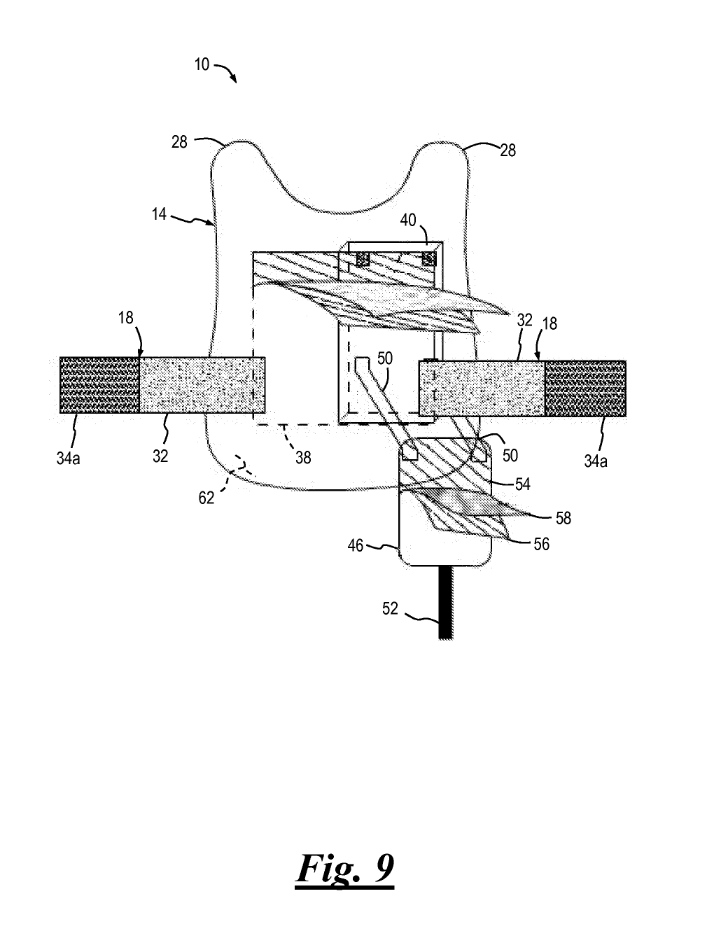

With reference now to FIGS. 8 and 9, an interior portion 62 of back panel 14 may also include one or more pockets 38 having an opening 40 sized and shaped to receive a cooling pack 42. An insulative pad 46 is selectably attached to pocket 38 by one or more pad fasteners 48. Pad 46 is also joined to pocket 38 by one or more pad straps 50, the pad straps having a length sufficient to move the pad away from the pocket. One or more pull tabs 52 are joined to pad 46 and extend below the pad.

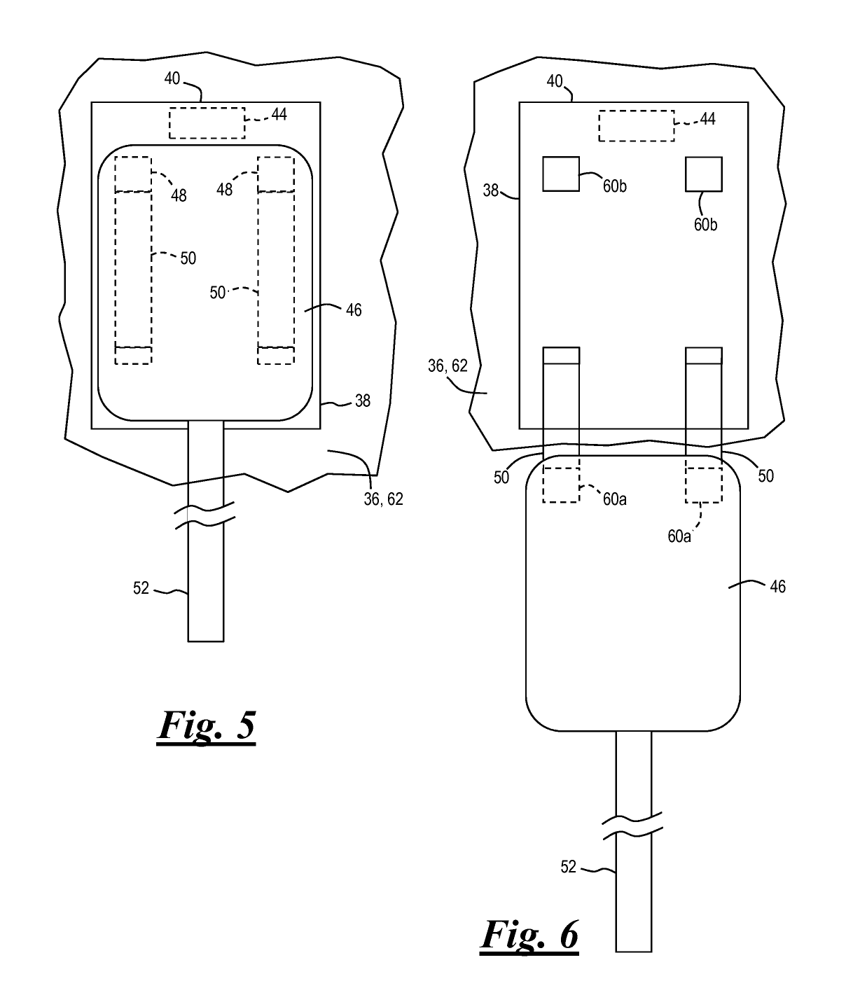

To use thermal vest 10, cooling packs 42 corresponding to pockets 38 are first pre-cooled (preferably frozen) in a freezer. Referring to FIG. 5 the user, who is normally at least wearing one layer of clothing on their torso, inserts the cooled cooling packs 42 into corresponding pockets 38 through openings 40 of the respective pockets. Hand pressure may then be applied to pocket fasteners 44 to close off openings 40 and retain cooling packs 42 in their respective pockets. Pads 46 are secured to corresponding pockets 38 with pad fasteners 48 (FIG. 5), the pads thus being in a stowed position facially adjacent the pockets. Prior to donning thermal vest 10, shoulder fasteners 16 and torso fasteners 18 are typically in the fastened position and front panel fastener 26 is in an unfastened position. The user places his or her arms through openings formed between the fastened shoulder fasteners 16 and torso fasteners 18 of the left and right sides of thermal vest 10, then fastens front panel fastener 26 to secure thermal vest 10 to the wearer's body. Shoulder fasteners 16 and torso fasteners 18 may be adjusted as desired to fit thermal vest 10 to the size of the wearer.

When thermal vest 10 is initially worn after installing the frozen cooling packs 42, the stowed insulative pads 46 between pockets 38 and the wearer's skin (FIGS. 2, 4, 5) act as insulators to protect the wearer from excessive cooling and risk of frostbite due to exposure to the insulative pad. The insulative nature of pads 46 also extends the amount of time for cooling packs 42 to melt and warm to the ambient temperature of the surrounding environment, thereby extending the amount of time the cooling packs are useful for cooling the torso of the wearer.

As cooling packs 42 melt they gradually become less effective for cooling the wearer. With reference to FIGS. 5 and 6, the wearer may then pull downwardly on pull tabs 52, overcoming the holding force of pad fasteners 48 and moving insulative pads 46 downwardly and away from pockets 38 to a non-facially adjacent deployed position, thereby placing the skin of the wearer more nearly in contact with the cooling packs and enabling the wearer to more effectively utilize the remaining cooling effect of the partially-depleted cooling packs. Pull tabs 52 are accessible to the wearer of thermal vest 10 while wearing the vest, obviating the need to remove the vest to reposition pads 46. In addition, pad straps 50 retain pads 46 to thermal vest 10 to prevent their being accidentally misplaced after removal from pockets 38. While in the deployed position of FIG. 6, pads 46 are below pockets 38 and generally aligned with the pockets, to prevent discomfort to the wearer by the removed pads.

In another embodiment of the present invention cooling packs 42 may be interchangeable with heating packs 64 (FIG. 7) having a similar size and shape. Accordingly, the term “thermal pack” herein is understood to refer to both cooling packs and heating packs within the scope of the present invention.

Heating packs 64 may be any type of heating device now known or later invented including, without limitation, electrically heated devices, chemically-reactive heating devices, phase change materials, and packs containing a material having a high specific heat capacity which, when heated in a warming oven or microwave oven, gradually releases the heat over time.

When heating packs 64 are installed in pockets 38 instead of cooling packs 42, thermal vest 10 may be used as a heating vest. Such a vest may be used to advantage in low-temperature situations such as out-of-doors in cold weather or in refrigerated spaces.

While this invention has been shown and described with respect to a detailed embodiment thereof, it will be understood by those skilled in the art that changes in form and detail thereof may be made without departing from the scope of the claims of the invention.

What is claimed is:

1. A thermal vest, comprising:
a front panel sized and shaped to substantially cover a front of a wearer's torso;
a back panel spaced apart from and opposing the front panel, the back panel being sized and shaped to cover a back of the wearer's torso;
at least one pocket on an interior of at least one of the panels, the pocket having an opening sized and shaped to receive a thermal pack; and
an insulative pad selectably attached to the pocket, the insulative pad being selectably movable between a stowed position facially adjacent the pocket and a deployed, non-adjacent position away from the pocket,
the insulative pad providing thermal insulation between the pocket and the wearer in the stowed position, the insulative pad being movable by the wearer to the deployed position when said thermal insulation is not desired.

2. The thermal vest of claim 1 wherein the front panel further comprises a left sub-panel and a right sub-panel.

3. The thermal vest of claim 2, further including a front panel fastener to selectably couple together the left and right sub-panels.

4. The thermal vest of claim 3 wherein the front panel fastener is a zipper.

5. The thermal vest of claim 1, further comprising a pair of shoulder fasteners extending between the front panel and the back panel.

6. The thermal vest of claim 5 wherein the shoulder fasteners comprise hook and loop fasteners.

7. The thermal vest of claim 1, further comprising a pair of torso fasteners extending between the front panel and the back panel.

8. The thermal vest of claim 7 wherein the torso fasteners comprise hook and loop fasteners.

9. The thermal vest of claim 1 wherein the insulative pad is tethered to the pocket with a pad strap.

10. The thermal vest of claim 1 wherein the insulative pad is selectably attached to the pocket with a pad fastener;

11. The thermal vest of claim 1 wherein the insulative pad further includes a pull tab extending away from the pad.

12. The thermal vest of claim 1, further including a pocket fastener to selectably close off the opening of the pocket.

13. The thermal vest of claim 1 wherein the insulative pad includes an inner layer, an outer layer, and a thermal protective insulating layer between the inner and outer layers.

14. The thermal vest of claim 13 wherein the thermal protective insulating layer is at least one of THINSULATE and polyethylene foam.

15. The thermal vest of claim 1 wherein at least one of the front panel and the back panel are made from at least one of flame-resistant nylon, polyester-cotton blends, NOMEX, THINSULATE and GORE-TEX.

16. The thermal vest of claim 1 wherein the thermal pack is a cooling pack.

17. The thermal vest of claim 1 wherein the thermal pack is a heating pack.

18. A thermal vest, comprising:
a front panel sized and shaped to substantially cover a front of a wearer's torso, the front panel having a left sub-panel and a right sub-panel;
a front panel fastener to selectably couple together the left and right sub-panels;
a back panel spaced apart from and opposing the front panel, the back panel being sized and shaped to cover a back of the wearer's torso;
a pair of shoulder fasteners extending between the front panel and the back panel;
a pair of torso fasteners extending between the front panel and the back panel;
at least one pocket on an interior of at least one of the panels, the pocket having an opening sized and shaped to receive a thermal pack; and
an insulative pad selectably attached to the pocket, the insulative pad being selectably movable between a stowed position facially adjacent the pocket and a deployed, non-adjacent position away from the pocket,
the insulative pad providing thermal insulation between the pocket and the wearer in the stowed position, the insulative pad being movable by the wearer to the deployed position when said thermal insulation is not desired.

19. The thermal vest of claim 18 wherein the insulative pad is tethered to the pocket with a pad strap.

20. The thermal vest of claim 18 wherein the insulative pad further includes a pull tab extending away from the pad.
